(19) United States
(12) Patent Application Publication
(10) Pub. No.: US 2021/0125131 A1
(43) Pub. Date: Apr. 29, 2021

(54) ELECTRONIC DEVICE, METHOD FOR CONSTRUCTING SCORING MODEL OF RETAIL OUTLETS, SYSTEM, AND COMPUTER READABLE MEDIUM

(71) Applicant: Ping An Technology (Shenzhen) Co., Ltd., Shenzhen, Guangdong (CN)

(72) Inventors: Kun Deng, Shenzhen, Guangdong (CN); Wei Han, Shenzhen, Guangdong (CN); Jianming Wang, Shenzhen, Guangdong (CN); Jing Xiao, Shenzhen, Guangdong (CN)

(73) Assignee: Ping An Technology (Shenzhen) Co., Ltd., Shenzhen, Guangdong (CN)

(21) Appl. No.: 16/097,273

(22) PCT Filed: Oct. 31, 2017
(86) PCT No.: PCT/CN2017/108792

§ 371 Date: Oct. 28, 2018

(30) Foreign Application Priority Data
Sep. 30, 2017 (CN) 201710914523.0

(51) Int. Cl. G06Q 10/06; G06Q 30/02; G06F 16/951; G06F 16/9537; G06N 20/20

(52) U.S. Cl. CPC G06Q 10/06393; G06Q 30/0205; G06N 5/003; G06F 16/9537; G06N 20/20; G06F 16/951

(57) ABSTRACT

The present disclosure provides an electronic device, a method for constructing a scoring model of retail outlets, a system and a computer readable medium. The method includes: crawling POI data of a predetermined map website by a crawler system; acquiring surrounding POI data based on a location of each retail outlet, and constructing POI relevant outlet features based on the surrounding POI data; acquiring surrounding LBS information based on the location of each retail outlet, and constructing client relevant features based on the surrounding LBS information; scoring each retail outlet based on a number of new clients increased in a predetermined time period and a revenue index; and constructing the scoring model by performing supervised learning of a preset classification algorithm model using the POI relevant outlet feature, the client relevant feature, and a score of the retail outlet.

### CROSS-REFERENCE TO RELATED APPLICATION

The present application claims priority to Chinese Patent Application No. 201710914523.0 entitled “ELECTRONIC DEVICE, METHOD FOR CONSTRUCTING SCORING MODEL OF RETAIL OUTLETS, SYSTEM, AND COMPUTER READABLE MEDIUM” filed on Sep. 30, 2017, the contents of which are expressly incorporated by reference herein in its entirety.

### TECHNICAL FIELD

The present disclosure relates to the field of an electronic device, a method for constructing a scoring model of retail outlets, a system, and a computer readable medium.

### BACKGROUND

At present, a site of a retail outlet is selected in a manner of a subjective judgment combined with a site inspection surrounding a business district and a residential area during selecting a site of a retail outlet of a financial industry. The manner of selecting the site of the retail outlet is subjective, which cannot assess an overall situation of the site of the outlet in objective and integral conjunction with surrounding factors. Thus, a project constructed for assessing the site of the retail outlet in objective and integral conjunction with surrounding factors becomes one of the problems to be solved.

### SUMMARY OF THE INVENTION

The present disclosure involves an electronic device, a method for constructing a scoring model of retail outlets, a system, and a computer readable medium, aiming to construct the scoring model of the retail outlets in objective and integral conjunction with surrounding factors.

To achieve the aim, the present disclosure provides an electronic device. The electronic device includes a processor, a storage device connected with the storage, and a system for constructing a scoring model of retail outlets stored in the storage device; when being executed by the processor, the system performs the following steps:

Step S1, crawling point of interest (POI) data of a predetermined map website by a crawler system;

Step S2, acquiring surrounding POI data based on a location of each retail outlet, and constructing a POI relevant outlet feature of each retail outlet based on the surrounding POI data of each retail outlet;

Step S3, acquiring surrounding location based service (LBS) information of each retail outlet based on the location of each retail outlet, and constructing a client relevant feature of each retail outlet based on the surrounding LBS information of each retail outlet;

Step S4, scoring each retail outlet based on a number of new clients increased in a predetermined time period and a revenue index of each retail outlet;

Step S5, constructing a scoring model of the retail outlets by performing supervised learning of a preset classification algorithm model using the POI relevant outlet feature, the client relevant feature, and a score of each retail outlet.

The present disclosure further provides a method for constructing a scoring model of retail outlets. The method for constructing a scoring model of the retail outlets being executed by the processor includes following steps.

Step S1, crawling point of interest (POI) data of a predetermined map website by a crawler system;

Step S2, acquiring surrounding POI data based on a location of each retail outlet, and constructing a POI relevant outlet feature based on the surrounding POI data;

Step S3, acquiring surrounding location based service (LBS) information of each retail outlet based on the location of each retail outlet, and constructing a client relevant feature of each retail outlet based on the surrounding LBS information of each retail outlet;

Step S4, scoring each retail outlet based on a number of new clients increased in a predetermined time period and a revenue index of each retail outlet;

Step S5, constructing a scoring model of retail outlet by performing supervised learning of a preset classification algorithm model using the POI relevant outlet feature, the client relevant feature, and a score of each retail outlet.

The present disclosure further provides a system for constructing a scoring model of retail outlets. The system for constructing the scoring model of the retail outlets includes:

a crawling module, configured to crawl point of interest (POI) data of a predetermined map website by a crawler system;

a first constructing module, configured to acquire surrounding POI data each retail outlet based on a location of each retail outlet, and construct a POI relevant outlet feature based on the surrounding POI data;

a second constructing module, configured to acquire a location based service (LBS) information surrounding each retail outlet based on the location of each retail outlet, and construct a client relevant feature of each retail outlet based on the LBS information of each retail outlet;

a scoring module, configured to score each retail outlet based on a number of new clients increased in a predetermined time period and a revenue index of each retail outlet; and

a third constructing module, configured to construct a scoring model of retail outlet by performing supervised learning of a preset classification algorithm model using the POI relevant outlet feature, the client relevant feature, and a score of each retail outlet.

The present disclosure further provides a computer readable medium.

The computer readable medium stores a system for constructing a scoring model of retail outlets. When being executed by at least one processor, the system for constructing the scoring model of the retail outlets performs following steps:

Step S1, crawling point of interest (POI) data of a predetermined map website by a crawler system;

Step S2, acquiring surrounding POI data based on a location of each retail outlet, and constructing a POI relevant outlet feature based on the surrounding POI data;

Step S3, acquiring surrounding location based service (LBS) information of each retail outlet based on the location of each retail outlet, and constructing a client relevant feature of each retail outlet based on the surrounding LBS information of each retail outlet;

Step S4, scoring each retail outlet based on a number of new clients increased in a predetermined time period and a revenue index of each retail outlet; and

Step S5, constructing a scoring model of retail outlet by performing supervised learning of a preset classification algorithm model using the POI relevant outlet feature, the client relevant feature, and a score of each retail outlet.

The beneficial effects of the present disclosure are described as follow. The present disclosure constructs the scoring model of the retail outlets based on the POI relevant outlet feature relevant to the POI data of each retail outlet, the client relevant feature relevant to on the LBS information, and a score of each retail outlet. The POI relevant feature and the client relevant feature are based on a big data, and are the mainly factors affecting the retail outlets, thus the scoring model of the retail outlets based on the POI relevant feature and the client relevant feature assesses an overall situation of a location of the outlet in objective and integral conjunction with surrounding factors.

### BRIEF DESCRIPTION OF THE FIGURES

FIG. 1 is a schematic view of an optional application environment of each embodiment of the present disclosure.

FIG. 2 is a flowchart of a method for constructing a scoring model of retail outlets in accordance with an embodiment of the present disclosure.

FIG. 3 is a detail flowchart of a step S2 of FIG. 2.

FIG. 4 is a detail flowchart of a step S3 of FIG. 2.

### DETAILED DESCRIPTION OF THE EMBODIMENTS

Technical solutions of the present invention are further described in detail with reference to the accompanying drawings and the embodiments. It will be understood that the specific embodiments described herein are merely used for describing the present invention, but are not intended to limit the present invention.

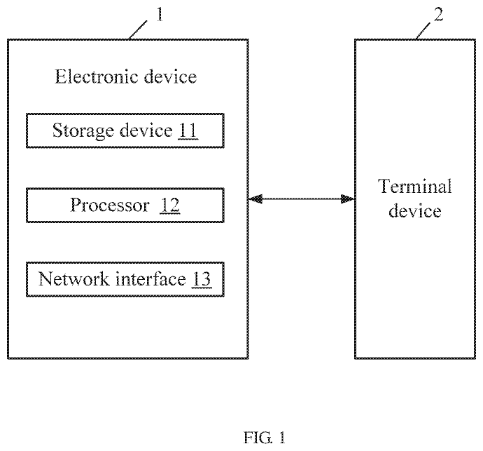

With reference to FIG. 1, FIG. 1 illustrates an optional application environment of each embodiment of the present disclosure. The optional application environment includes an electronic device 1 and a terminal device 2. The electronic device 1 exchanges data with the terminal device 2 by a suitable technology, such as a network and a near field communication technology.

The terminal device 2 includes, but not limited to any type of electronic device communicated with users through a keyboard, a mouse, a remote controller, a touch pad, or a voice control device. The electronic device can be a mobile device, for example, a personal computer, a tablet PC, a smart phone, a personal digital assistant (PDA), a game console, an internet protocol television (IPTV), a smart wearable device, and a navigation device. As another example, the electronic device can be a fixed terminal, such as digital television, a desktop computer, a notebook, or a server. The terminal device 2 is used for receiving instructions of constructing a scoring model of retail outlets, receiving a location of the new retail outlet selected by a user, and so on.

The electronic device 1 is a device for automatically calculating and/or information processing according to preset or stored instructions. The electronic device 1 can be a computer, a single network server, a server group formed by multiple network servers, a cloud formed by a plurality of web servers or hosts based on cloud computing. The cloud computing is a distributed computing, and is a super virtual computer, which is consisted of a group of loosely coupled computer sets.

In the present embodiment, the electronic device 1 can includes, but not limited to a storage device 11, a processor 12, and network interface 13, which are communicated with each through a system bus. The storage device 11 stores a system for constructing a scoring model of retail outlets executed by the processor 12. It should be point out that FIG. 1 only shows the electronic device 1 with the components 11-13. But, it should be understood that the components can be more or less in other disclosures.

The storage device 11 includes a memory and at least one type of readable storage medium. The memory provides cache for the operation of the electronic device 1. The readable storage medium is a non-volatile memory, such as a flash memory, a hard disk, multi-media card, a card type storage (for example, a SD or a DX storage), a read-access memory (RAM), a static read-access memory (SRAM), a read-only memory (ROM), an electrically programmable read-only memory (EEPROM), a programmable read-only memory (PROM), a magnetic memory, a magnetic disk, or an optical disk. In some embodiments, the readable storage medium can be an internal storage unit of the electronic device 1, such as a hard disk of the electronic device 1. In other embodiments, the non-volatile memory can be an external storage device, such as a plug-in hard disk, a smart media card (SMC), a secure digital (SD) card, or a flash card. In this embodiment, the readable medium of the storage device 11 stores an operating system and various types of software of the electronic device 1, such as program codes of the system for constructing the scoring model of the retail outlets in the embodiment of the present disclosure. Besides, the storage device 11 also temporarily stores various to-be-outputted or outputted data.

In some embodiment, the processor 12 can be a central processing unit (CPU), a controller, a micro controller, a micro processor, or any other data processing chip. The processor 12 usually controls a general operation of the electronic device 1, such as implementing a data exchanging with the terminal device 2, or a controlling and processing relevant to the communications. In the present disclosure, the processor 12 is used for running the programming code stored in the storage device 11 or processing the data, such as a system for constructing a scoring model of the retail outlets.

The network interface 13 can include a wireless network interface or a wired network interface. The network interface 13 is usually used for establishing a communication connection between the electronic device 1 and other electric devices. In this embodiment, the network interface 13 is primarily used for connecting the electronic device 1 with one or more terminal device 2, and establishing the communication connection between the electronic device 1 and one or more terminal device 2.

The system for constructing the scoring model of the retail outlets stored in the storage device 11 includes at least one readable instruction stored in the storage device 11. The at least one readable instruction is capable of being implemented by the processor 12 for achieving a method for constructing a scoring mode of retail outlets of each embodiment of the present disclosure. The computer readable instructions are divided into different logic module based on the executed functions of different parts. The present disclosure includes a crawling module, a first constructing module, a second constructing module, a scoring module, and a third constructing module.

The system for constructing the scoring model of the retail outlets, when executed by the processor 12, performs following steps.

Step S1, crawling point of interest (POI) data of a predetermined map website by a crawler system.

In the present disclosure, the crawler system automatically crawls programs or scripts of the worldwide web according to a predetermined rule. In the present disclosure, the point of interest (POI) data of the mainstream map websites is crawled by the crawler system. The mainstream maps include the Google Map, the Amap, the Bing Map, the Baidu Map, the Tencent Map, and so on. Table 1 illustrates a POI data.

TABLE 1

| Name | y | x | Address | Type | Tag |
|---|---|---|---|---|---|
| **garden | 31.18695 | 120.4967 | No. 218 | residential | residential |
| residential | | | Changli | area | area |
| area | | | Road, | | |
| | | | Pudong New | | |
| | | | District | | |

Each item of POI data includes three basic elements, which are a name, a longitude and latitude, and a feature. In the table 1, the name is “**garden residential area”, the longitude and latitude is “y31.18695, x120.4967”, the feature is “address: No. 218 Changli Road, Pudong New District, type: residential area, tag: residential area”.

Step S2, acquiring surrounding POI data based on a location of each retail outlet, and constructing a POI relevant outlet feature based on the surrounding POI data.

In the present disclosure, the retail outlets mainly refer to financial retail outlets, but also can be other types of retail outlets. The current retail outlets are already-existed retail outlets. The location is a longitude and latitude of the retail outlet. The surrounding POI data is the POI data within one kilometer from the retail outlet. The surrounding POI data of each retail outlet includes the relevant outlets surrounding the retail outlet. For example, a financial retail outlet is closely relevant with a crowd density, thus the relevant outlet of the retail outlet can include shopping malls, subway stations, residential areas, and restaurants, and so on. In the present disclosure, the type and the number of the relevant outlets of the retail outlet are constituted as the POI relevant outlet feature.

Step S3, acquiring surrounding location based service (LBS) information of each retail outlet based on the location of each retail outlet, and constructing a client relevant feature of each retail outlet based on the surrounding LBS information of each retail outlet.

In the present disclosure, the surrounding LBS information is acquired based on the location of each retail outlet, for example, the surrounding LBS information within one kilometer from each retail outlet is acquired based on the location of each retail outlet. The LBS information is location information (such as geographic coordinates or geodetic coordinates) of the mobile terminal users acquired by a wireless communication website of a telecom motion operator (such as a GSM network or a CDMA network) or an external locating manner (e.g., GPS). The terminal identification information, such as a mobile number of a mobile terminal user, is acquired by the location information. The basic information of the client is acquired by linking with the database based on the terminal identification information, such as a cell-phone number of a mobile terminal user. The basic information of the client includes age, qualification, incomes, address, family members, and so on.

In the present disclosure, the basic user information is obtained by acquiring the surrounding LBS information of the retail outlet in the predetermined time period. The basic information of the client is also obtained by acquiring the surrounding LBS information of the retail outlet in multiple predetermined time periods and extracting a predetermined number of the surrounding LBS information of the retail outlet. The basic information of the client forms the client relevant feature of the retail outlet.

Step S4, scoring each retail outlet based on a number of new clients increased in a predetermined time period and a revenue index of each retail outlet.

The retail outlet is scored based on the number of new clients increased in the predetermined time period (such as a month) and the revenue index of the retail outlet. For the retail outlet of the bank type, the security type, and the insurance type, the revenue index includes a profitability status, a business growth status, an asset quality status, a solvency status, and so on. In the present disclosure, the more new clients increased in the predetermined time period and the higher revenue index, the higher the score of the retail outlet; otherwise, the less new clients increased in the predetermined time period and the lower revenue index, the lower the score of the retail outlet.

In other embodiments, the retail outlet can be leveled according to the number of the new clients increased in the predetermined time period and the revenue index. The more new clients increased in the predetermined time period and the higher revenue index, the higher level of the retail outlet, and the high-level retail outlet is the high-quality retail outlet. Otherwise, the less new clients increased in the predetermined time period and the lower revenue index, the lower level of the retail outlet, and the retail outlet is considered as an ordinary one.

Step S5, constructing a scoring model of retail outlets by performing supervised learning of a preset classification algorithm model using the POI relevant outlet feature, the client relevant feature, and a score of each retail outlet.

The preset classification algorithm model includes a plurality of types. Preferably, the preset classification algorithm model in the present disclosure is a random forest model.

In the disclosure, the constructing a scoring model of retail outlet by performing supervised learning a preset classification algorithm model using the POI relevant outlet feature, the client relevant feature, and a score of each retail outlet includes steps as follows.

Acquiring a first predetermined number (such as 10000) of the retail outlets, and using the POI relevant outlet features, the client relevant features, and scores of the first predetermined number of the retail outlets as a training set.

Acquiring a second predetermined number (such as 5000) of the retail outlets, and using the POI relevant outlet features, the client relevant features, and scores of the second predetermined number of the retail outlets as a checking set.

Training the random forest model using the training set.

Checking a scoring accuracy rate of the trained random forest model using the checking set.

When the scoring accuracy rate is larger than or equal to the preset scoring accuracy rate (such as 0.985), the training operation is ended, and the trained random forest model is served as the constructed scoring model of retail outlet. When the scoring accuracy rate is less than the preset scoring accuracy rate, the number of the retail outlets is increased in the training set for re-training the random forest model, until the scoring accuracy rate is larger than or equal to the preset scoring accuracy rate, the training operation is ended, and the trained random forest model is served as the constructed scoring model of retail outlet.

By comparing with the prior art, in the present disclosure the scoring model of the retail outlet is constructed by POI relevant outlet feature based on the POI data of each retail outlet, the client relevant feature based on the LBS information, and a score of each outlet. Due to the POI relevant feature and the client relevant feature are based on a big data, and are the mainly factor affected the retail outlet, thus the scoring model of the retail outlet based on the POI relevant feature and the client relevant feature assesses an overall situation of a location of the outlet in objective and integral conjunction with surrounding factors.

In an embodiment, based on the disclosure of FIG. 1, when being executed by the processor, the system for constructing a scoring model of the retail outlets further performs a following step.

After a new retail outlet is selected, inputting a POI relevant outlet feature and a client relevant feature corresponding to a location of the new retail outlet into the scoring model of the retail outlets, and scoring the new retail outlet by the scoring model of the retail outlets.

In the present disclosure, the POI relevant outlet feature is constructed based on the location of the new retail outlet and the POI data corresponding to the new retail outlet after the new retail outlet is selected. The client relevant feature is constructed based on the location of the new retail outlet and the LBS information corresponding to the new retail outlet. The POI relevant outlet feature and the client relevant feature corresponding to the location of the new retail outlet are inputted into the scoring model of retail outlets. By using the scoring model of retail outlets to score the new retail outlet, an overall situation of a location of the outlet is fully assessed in objective and integral conjunction with surrounding factors, for assessing advantages and disadvantages of the location of the new retail outlet.

In an embodiment, based on the disclosure of FIG. 1, the step S2 includes steps as follows.

S21, acquiring the POI data within a predetermined area of each retail outlet using the location of each current retail outlet as a center, and acquiring the relevant outlets of a predetermined type from the POI data;

S22, classifying and counting the relevant outlets of the predetermined type, and linking the relevant outlets of the predetermined type with the retail outlets to obtain the POI relevant outlet feature of the relevant retail outlet.

In the disclosure, using a location of each retail outlet as a center, the POI data within a predetermined area (such as within 1 kilometre) of each retail outlet are acquired. The relevant outlets of a predetermined type are obtained from the POI data. The relevant outlets can include shopping malls, subway stations, residential areas, restaurants, and so on. The relevant outlets are classified (for example, the supermarket and the shopping mall, which are classified as a shopping mall type) and the number of the relevant outlets of each type is counted. For example, as the shopping mall type, the number of the shopping mall is counted. The classified and counted relevant outlet is linked with the retail outlet to obtain the POI relevant outlet feature of the retail outlet.

It can be understand that, the POI relevant outlet feature is relevant with the types and the numbers of the surrounding relevant outlets. The more types of the surrounding relevant outlets and the greater number of the surrounding relevant outlets become, the more possibility of the retail outlet become a quality retail outlet.

In an embodiment, based on the disclosure of FIG. 1, the step S3 includes steps as follows.

S31, acquiring the LBS information of each retail outlet within in a predetermined area using the location of each current retail outlet as a center. For example, acquiring the LBS information within one kilometre from the retail outlet at a predetermined time point.

S32, acquiring identification information of a mobile terminal based on the LBS information, and acquiring client information from a database based on the identification information of the mobile terminal. The identification information of the mobile terminal includes a cell-phone number, an identification of the mobile terminal, and so on. The identification information is compared with the client information in the database to obtain the corresponding client information. The client information includes service information and basic information of the client.

S33, statistically analyzing the client information, and linking the client information with the retail outlet to obtain the client relevant feature of the retail outlet. The statistical analysis of the client information includes statistics of clients' age stage, educational distribution, income state, job distribution, address distribution, number of the family members, and so on. The statistical analysis result is linked with the retail outlet to obtain the client relevant feature of the retail outlet.

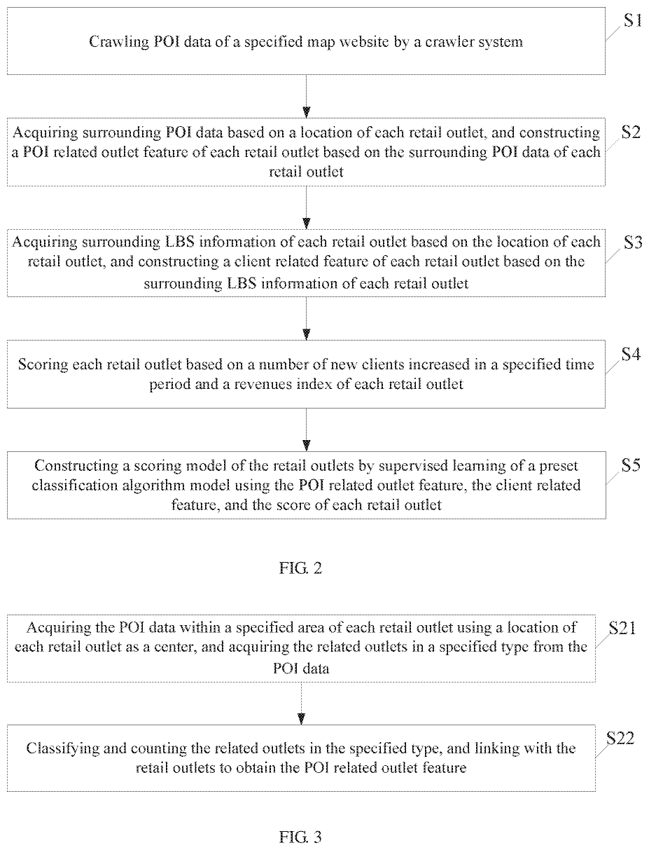

Referring to FIG. 2, FIG. 2 illustrates a flowchart view of the present disclosure of a method for constructing a scoring model of the retail outlet. The method for constructing a scoring model of the retail outlet comprising:

Step S1, crawling point of interest (POI) data of a predetermined map website by a crawler system.

In the present disclosure, the crawler system automatically crawls programs or scripts of the worldwide web according to a predetermined rule. In the present disclosure, the point of interest (POI) data of the mainstream map websites is crawled by the crawler system. The mainstream maps include the Google Map, the Amap, the Bing Map, the Baidu Map, the Tencent Map, and so on. Table 1 illustrates a POI data. In table 1, each entry of each POI data includes three basic elements, which are a name, a longitude and latitude, and a feature. In the table 1, the name is “**garden residential area”, the longitude and latitude is “y31.18695, x120.4967”, the feature is “address: No. 218 Changli Road, Pudong New District, type: residential area, tag: residential area”.

Step S2, acquiring surrounding POI data based on locations of each retail outlet, and constructing a POI relevant outlet feature based on the surrounding POI data.

In the present disclosure, the retail outlets mainly refer to financial retail outlets, but also can be other types of retail outlet. The current retail outlets are already-existed retail outlets. The location is a longitude and latitude of the retail outlet. The distance of the surrounding POI data is within one kilometer from the retail outlet. The surrounding POI data of each retail outlet includes the relevant outlets surrounding the retail outlet. For example, a financial retail outlet is closely relevant with a crowd density, thus the relevant outlet of the retail outlet can include shopping malls, subway stations, residential areas, and restaurants, and so on. In the present disclosure, the type and the number of the relevant outlets of the retail outlet form the POI relevant outlet feature.

Step S3, acquiring surrounding location based service (LBS) information of each retail outlet based on the location of each retail outlet, and constructing a client relevant feature of each retail outlet based on the surrounding LBS information of each retail outlet.

In the present disclosure, the surrounding LBS information are acquired based on the location of each retail outlet, for example, the distance of the surrounding LBS information within one kilometre from each retail outlet is acquired based on the location of each retail outlet. The LBS information is location information (such as geographic coordinates or geodetic coordinates) of the mobile terminal users acquired by a wireless communication website of a telecom motion operator (such as a GSM network or a CDMA network) or an external locating manner (e.g., GPS). The terminal identification information, such as a mobile number of a mobile terminal user, is acquired by the location information. The basic information of the client is acquired by linking with the database based on the terminal identification information, such as a cell-phone number of a mobile terminal user. The basic information of the client includes the age, the qualification, the incomes, the address, the family members, and so on.

In the present disclosure, the basic information of the client is obtained by acquiring the surrounding LBS information of the retail outlet in the predetermined time period or in multiple predetermined time periods and extracting a predetermined number of the surrounding LBS information of the retail outlet. The basic information of the client forms the client relevant feature of the retail outlet.

Step S4, scoring each retail outlet based on a number of new clients increased in a predetermined time period and a revenue index of each retail outlet.

The retail outlet is scored based on the number of new clients increased in the predetermined time period (such as a month) and the revenue index of the retail outlet. For the retail outlet of the bank type, the security type, and the insurance type, the revenue index includes a profitability status, a business growth status, an asset quality status, a solvency status, and so on. In the present disclosure, the more new clients increased in the predetermined time period and the higher revenue index, the higher the score of the retail outlet; otherwise, the less new clients increased in the predetermined time period and the lower revenue index, the lower the score of the retail outlet.

In other embodiments, the retail outlet can be leveled according to the number of the new clients increased in the predetermined time period and the revenue index. The more new clients increased in the predetermined time period and the higher revenue index, the higher level of the retail outlet, and the high-level retail outlet is the high-quality retail outlet. Otherwise, the less new clients increased in the predetermined time period and the lower revenue index, the lower level of the retail outlet, and the retail outlet is considered as an ordinary one.

Step S5, constructing a scoring model of retail outlets by performing supervised learning of a preset classification algorithm model using the POI relevant outlet feature, the client relevant feature, and a score of each retail outlet.

The preset classification algorithm model includes a plurality of types. Preferably, the preset classification algorithm model in the present disclosure is a random forest model.

In the disclosure, the constructing a scoring model of retail outlet by performing supervised learning a preset classification algorithm model using the POI relevant outlet feature, the client relevant feature, and a score of each retail outlet further includes steps as follows.

Acquiring a first predetermined number (such as 10000) of the retail outlets, and using the POI relevant outlet features, the client relevant features, and scores of the first predetermined number of the retail outlets as a training set.

Acquiring a second predetermined number (such as 5000) of the retail outlets, and using the POI relevant outlet features, the client relevant features, and scores of the second predetermined number of the retail outlets as a checking set.

Training the random forest model using the training set.

Checking a scoring accuracy rate of the trained random forest model using the checking set.

When the scoring accuracy rate is larger than or equal to the preset scoring accuracy rate (such as 0.985), the training operation is ended, and the trained random forest model is served as the constructed scoring model of retail outlet. When the scoring accuracy rate is less than the preset scoring accuracy rate, the number of the retail outlet in the training set is increased for re-training the random forest model, until the scoring accuracy rate is larger than or equal to the preset scoring accuracy rate, the training operation is ended, and the trained random forest model is served as the constructed scoring model of retail outlet.

By comparing with the prior art, in the present disclosure the scoring model of the retail outlet is constructed by POI relevant outlet feature based on the POI data of each retail outlet, the client relevant feature based on the LBS information, and a score of each outlet. Due to the POI relevant feature and the client relevant feature based on a big data, which are the mainly factor affected the retail outlet, thus the scoring model of the retail outlet based on the POI relevant feature and the client relevant feature assesses an overall situation of a location of the outlet in objective and integral conjunction with surrounding factors.

In an embodiment, based on the disclosure of FIG. 2, the method for constructing a scoring model of the retail outlets further includes a follow step.

After a new retail outlet is selected, inputting a POI relevant outlet feature and a client relevant feature corresponding to a location of the new retail outlet into the scoring model of the retail outlets, and scoring the new retail outlet by the system for constructing the scoring model of the retail outlets.

In the present disclosure, the POI relevant outlet feature is constructed based on the location of the new retail outlet and the POI data corresponding to the new retail outlet after the new retail outlet is selected. The client information is constructed based on the location of the new retail outlet and the LBS information corresponding to the new retail outlet. The POI relevant outlet feature and the client relevant feature corresponding to the location of the new retail outlet are inputted into the scoring model of retail outlets. By using the scoring model of retail outlets to score the new retail outlet, an overall situation of a location of the outlet is been fully assessed in objective and integral conjunction with surrounding factors, for assessing advantages and disadvantages of the location of the new retail outlet.

In an embodiment, as shown in FIG. 3, based on the disclosure of FIG. 2, the step S2 includes steps as follows.

S21, acquiring the POI data within a predetermined area of each retail outlet using the location of each current retail outlet as a center, and acquiring the relevant outlets of a predetermined type from the POI data;

S22, classifying and counting the relevant outlets of the predetermined type, and linking the relevant outlets of the predetermined type with the retail outlets to obtain the POI relevant outlet feature of the relevant retail outlet.

In the disclosure, using a location of each retail outlet as a center, the POI data within a predetermined area (such as within 1 kilometre) of each retail outlet are acquired. The relevant outlets of a predetermined type are obtained from the POI data. The relevant outlets can include shopping malls, subway stations, residential areas, restaurants, and so on. The relevant outlets are classified (such as the supermarket, and the shopping mall classified as a shopping mall type) and the number of the relevant outlets of each type is counted. For example, as the shopping mall type, the number of the shopping mall is counted. The classified and counted relevant outlet is linked with the retail outlet to obtain the POI relevant outlet feature of the retail outlet.

It can be understand that, the POI relevant outlet feature is relevant with the types and the number of the surrounding relevant outlets. The more types of the surrounding relevant outlets and the greater number of the surrounding relevant outlets become, the more possibility of the retail outlet become a quality retail outlet.

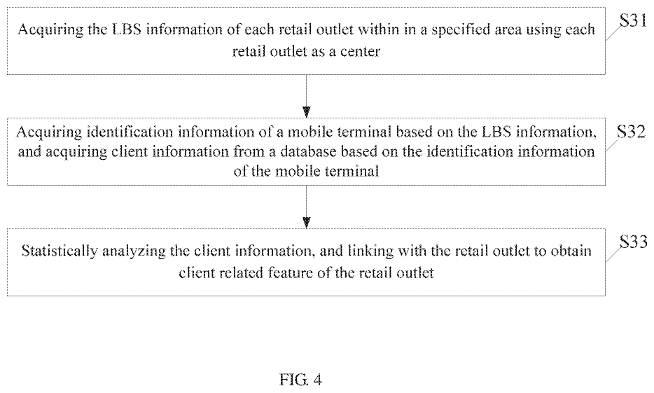

In an embodiment, as shown in FIG. 4, based on the disclosure of FIG. 2, the step S3 comprising:

S31, acquiring the LBS information of each retail outlet within in a predetermined area using the location of each current retail outlet as a center. For example, acquiring the LBS information within one kilometre from the retail outlet at a predetermined time point.

S32, acquiring identification information of a mobile terminal based on the LBS information, and acquiring client information from a database based on the identification information of the mobile terminal. The identification information of the mobile terminal includes a cell-phone number, an identification of the mobile terminal, and so on. The identification information is compared with the client information in the database to obtain the corresponding client information. The client information includes service information and basic information of the client.

S33, statistically analyzing the client information, and linking the client information with the retail outlet to obtain the client relevant feature of the retail outlet. The statistical analysis of the client information includes statistics of clients' age stage, educational distribution, income state, job distribution, address distribution, number of the family members, and so on. The statistical analysis result is linked with the retail outlet to obtain the client relevant feature of the retail outlet.

The present application also provides a computer readable storage medium. The computer readable storage medium stores a system for constructing the scoring model of the retail outlets. The system for constructing the scoring model of the retail outlets is executed by a processor to perform the steps of the above method for constructing a scoring model of the retail outlets.

The serial numbers of the above embodiments are only used for illustration and are not intended to represent advantages and disadvantages of these embodiments.

It will be apparent to those skilled in the art from the foregoing description that the embodiments described above may be executed by means of software plus the necessary general-purpose hardware platform. Although the embodiments described above may also be executed by hardware, the former would be advantageous in many cases. On the basic of such an understanding the substantial technical solution, or the part which contributes to the prior art or all or part of the technical solution of the disclosure, may be embodied as software products. Computer software products can be stored in a storage medium, e.g., ROM/RAM, magnetic disk, or optical disk, and can include multiple instructions causing a terminal device, e.g., a mobile phone, a computer, a server, a conditioner, a network device, etc., to execute all or part of the methods as described herein in various embodiments.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall into the protection scope of the present disclosure. Therefore, the protection scope of the present disclosure shall be subject to the protection scope of the claims.

1. An electronic device comprising:
a processor;
a storage device connected with the processor;
a system for constructing a scoring model of retail outlets stored in the storage device, when being executed by the processor, the system performing the following steps:
S1, crawling POI data of a predetermined map website by a crawler system;
S2, acquiring surrounding POI data of each retail outlet based on a location of each retail outlet, and constructing a POI relevant outlet feature based on the surrounding POI data;
S3, acquiring surrounding location based service (LBS) information of each retail outlet based on the location of each retail outlet, and constructing a client relevant feature of each retail outlet based on the surrounding LBS information of each retail outlet;
S4, scoring each retail outlet based on a number of new clients increased in a predetermined time period and a revenue index of each retail outlet; and
S5, constructing a scoring model of each retail outlet by performing supervised learning of a preset classification algorithm model using the POI relevant outlet feature, the client relevant feature, and a score of each retail outlet.

2. The electronic device according to claim 1, wherein the system for constructing a scoring model of the retail outlets further performs the following steps when being executed by the processor:
after a new retail outlet is selected, inputting a POI relevant outlet feature and a client relevant feature corresponding to a location of the new retail outlet into the scoring model of the retail outlets, and scoring the new retail outlet by the scoring model of the retail outlets.

3. The electronic device according to claim 1, wherein the step S2 comprises:
S21, acquiring the POI data within a predetermined area of each retail outlet using a location of each current retail outlet as a center, and acquiring relevant outlets of a predetermined type from the POI data; and
S22, classifying and counting the relevant outlets of the predetermined type, and linking the relevant outlets of the predetermined type with the retail outlets to obtain the POI relevant outlet feature of the relevant retail outlet.

4. The electronic device according to claim 1, wherein the step S3 comprises:
S31, acquiring the LBS information of each retail outlet within in a predetermined area using the location of each current retail outlet as a center;
S32, acquiring identification information of a mobile terminal based on the LBS information, and acquiring client information from a database based on the identification information of the mobile terminal; and
S33, statistically analyzing the client information and linking the client information with the retail outlet to obtain the client relevant feature of the retail outlet.

5. The electronic device according to claim 1 or 2, wherein the preset classification algorithm model is a random forest model, and the step S5 comprises:
acquiring a first predetermined number of the retail outlets, and using the POI relevant outlet features, the client relevant features, and scores of the first predetermined number of the retail outlets as a training set;
acquiring a second predetermined number of the retail outlets, and using the POI relevant outlet features, the client relevant features, and scores of the second predetermined number of the retail outlets as a checking set;
training the random forest model using the training set;
checking a scoring accuracy rate of the trained random forest model using the checking set;
ending the training operation and using the trained random forest model as the constructed scoring model of the retail outlets when the scoring accuracy rate is larger than or equal to a preset scoring accuracy rate; or
increasing the number of the retail outlets in the training set for re-training the random forest model when the scoring accuracy rate is less than the preset scoring accuracy rate.

6. A method for constructing a scoring model of retail outlets comprising:
S1, crawling POI data of a predetermined map website by a crawler system;
S2, acquiring surrounding POI data of each retail outlet based on a location of each retail outlet, and constructing a POI relevant outlet feature based on the surrounding POI data;
S3, acquiring surrounding location based service (LBS) information of each retail outlet based on the location of each retail outlet, and constructing a client relevant feature of each retail outlet based on the surrounding LBS information of each retail outlet;
S4, scoring each retail outlet based on a number of new clients increased in a predetermined time period and a revenue index of each retail outlet;
S5, constructing a scoring model of each retail outlet by performing supervised learning of a preset classification algorithm model using the POI relevant outlet feature, the client relevant feature, and a score of each retail outlet.

7. The method for constructing a scoring model of retail outlets according to claim 6, further comprising:
after a new retail outlet is selected, inputting a POI relevant outlet feature and a client relevant feature corresponding to a location of the new retail outlet into the scoring model of the retail outlets, and scoring the new retail outlet by the scoring model of the retail outlets.

8. The method for constructing a scoring model of retail outlets according to claim 6, wherein the step S2 comprises:
S21, acquiring the POI data within a predetermined area of each retail outlet using a location of each current retail outlet as a center, and acquiring relevant outlets of a predetermined type from the POI data;
S22, classifying and counting the relevant outlets of the predetermined type, and linking the relevant outlets of the predetermined type with the retail outlets to obtain the POI relevant outlet feature of the relevant retail outlet.

9. The method for constructing a scoring model of retail outlets according to claim 6, wherein the step S3 comprises:
S31, acquiring the LBS information of each retail outlet within in a predetermined area using the location of each current retail outlet as a center;
S32, acquiring identification information of a mobile terminal based on the LBS information, and acquiring client information from a database based on the identification information of the mobile terminal;
S33, statistically analyzing the client information, and linking the client information with the retail outlet to obtain the client relevant feature of the retail outlet.

10. The method for constructing a scoring model of retail outlets according to claim 6, wherein the preset classification algorithm model is a random forest model, and the step S5 comprises:
acquiring a first predetermined number of the retail outlets, and using the POI relevant outlet features, the client relevant features, and scores of the first predetermined number of the retail outlets as a training set;
acquiring a second predetermined number of the retail outlets, and using the POI relevant outlet features, the client relevant features, and scores of the second predetermined number of the retail outlets as a checking set;
training the random forest model using the training set;
checking a scoring accuracy rate of the trained random forest model using the checking set;
ending the training operation and using the trained random forest model as the constructed scoring model of the retail outlets when the scoring accuracy rate is larger than or equal to a preset scoring accuracy rate; or
increasing the number of the retail outlets in the training set for re-training the random forest model when the scoring accuracy rate is less than the preset scoring accuracy rate.

11-15. (canceled)

16. A computer readable storage medium, wherein the computer readable storage medium stores a system for constructing a scoring model of retail outlets, when being executed by at least one processor, the system performs the following steps:
S1, crawling POI data of a predetermined map website by a crawler system;
S2, acquiring surrounding POI data of each retail outlet based on a location of each retail outlet, and constructing a POI relevant outlet feature based on the surrounding POI data;
S3, acquiring surrounding location based service (LBS) information of each retail outlet based on the location of each retail outlet, and constructing a client relevant feature of each retail outlet based on the surrounding LBS information of each retail outlet;
S4, scoring each retail outlet based on a number of new clients increased in a predetermined time period and a revenue index of each retail outlet; and
S5, constructing a scoring model of retail outlet by performing supervised learning of a preset classification algorithm model using the POI relevant outlet feature, the client relevant feature, and a score of each retail outlet.

17. The computer readable storage medium according to claim 16, wherein the system further performs the following step when being executed by the at least one processor:
after a new retail outlet is selected, inputting a POI relevant outlet feature and a client relevant feature corresponding to a location of the new retail outlet into the scoring model of the retail outlets, and scoring the new retail outlet by the scoring model of the retail outlets.

18. The computer readable storage medium according to claim 16, wherein the step S2 comprises:
S21, acquiring the POI data within a predetermined area of each retail outlet using a location of each current retail outlet as a center, and acquiring relevant outlets of a predetermined type from the POI data; and
S22, classifying and counting the relevant outlets of the predetermined type, and linking the relevant outlets of the predetermined type with the retail outlets to obtain the POI relevant outlet feature of the relevant retail outlet.

19. The computer readable storage medium according to claim 16, wherein the step S3 comprises:
S31, acquiring the LBS information of each retail outlet within in a predetermined area using the location of each current retail outlet as a center;
S32, acquiring identification information of a mobile terminal based on the LBS information, and acquiring client information from a database based on the identification information of the mobile terminal; and
S33, statistically analyzing the client information and linking the client information with the retail outlet to obtain the client relevant feature of the retail outlet.

20. The computer readable storage medium according to claim 16, wherein the preset classification algorithm model is a random forest model, and the step S5 comprises:
acquiring a first predetermined number of the retail outlets, and using the POI relevant outlet features, the client relevant features, and scores of the first predetermined number of the retail outlets as a training set;
acquiring a second predetermined number of the retail outlets, and using the POI relevant outlet features, the client relevant features, and scores of the second predetermined number of the retail outlets as a checking set;
training the random forest model using the training set;
checking a scoring accuracy rate of the trained random forest model using the checking set;
ending the training operation and using the trained random forest model as the constructed scoring model of the retail outlets when the scoring accuracy rate is larger than or equal to a preset scoring accuracy rate; or
increasing the number of the retail outlet in the training set for re-training the random forest model when the scoring accuracy rate is less than the preset scoring accuracy rate.

21. The electronic device according to claim 2, wherein the step S2 comprises:
S21, acquiring the POI data within a predetermined area of each retail outlet using a location of each current retail outlet as a center, and acquiring relevant outlets of a predetermined type from the POI data; and
S22, classifying and counting the relevant outlets of the predetermined type, and linking the relevant outlets of the predetermined type with the retail outlets to obtain the POI relevant outlet feature of the relevant retail outlet.

22. The electronic device according to claim 2, wherein the step S3 comprises:
S31, acquiring the LBS information of each retail outlet within in a predetermined area using the location of each current retail outlet as a center;
S32, acquiring identification information of a mobile terminal based on the LBS information, and acquiring client information from a database based on the identification information of the mobile terminal; and
S33, statistically analyzing the client information and linking the client information with the retail outlet to obtain the client relevant feature of the retail outlet.

23. The electronic device according to claim 2, wherein the preset classification algorithm model is a random forest model, and the step S5 comprises:
acquiring a first predetermined number of the retail outlets, and using the POI relevant outlet features, the client relevant features, and scores of the first predetermined number of the retail outlets as a training set;
acquiring a second predetermined number of the retail outlets, and using the POI relevant outlet features, the client relevant features, and scores of the second predetermined number of the retail outlets as a checking set;
training the random forest model using the training set;
checking a scoring accuracy rate of the trained random forest model using the checking set;
ending the training operation and using the trained random forest model as the constructed scoring model of the retail outlets when the scoring accuracy rate is larger than or equal to a preset scoring accuracy rate; or
increasing the number of the retail outlets in the training set for re-training the random forest model when the scoring accuracy rate is less than the preset scoring accuracy rate.

24. The method for constructing a scoring model of retail outlets according to claim 7, wherein the step S2 comprises:
S21, acquiring the POI data within a predetermined area of each retail outlet using a location of each current retail outlet as a center, and acquiring relevant outlets of a predetermined type from the POI data;
S22, classifying and counting the relevant outlets of the predetermined type, and linking the relevant outlets of the predetermined type with the retail outlets to obtain the POI relevant outlet feature of the relevant retail outlet.

25. The method for constructing a scoring model of retail outlets according to claim 7, wherein the step S3 comprises:
S31, acquiring the LBS information of each retail outlet within in a predetermined area using the location of each current retail outlet as a center;
S32, acquiring identification information of a mobile terminal based on the LBS information, and acquiring client information from a database based on the identification information of the mobile terminal;
S33, statistically analyzing the client information, and linking the client information with the retail outlet to obtain the client relevant feature of the retail outlet.
